(19) United States
(12) Patent Application Publication
(10) Pub. No.: US 2003/0200842 A1
(43) Pub. Date: Oct. 30, 2003

(54) Hand tool device for use in the operation of quarter turn spring loaded self-ejecting or non spring loaded button type fasteners

(76) Inventor: Pasquale Anthony Iannone, Monroeville, NJ (US)

Correspondence Address: PASQUALE A. IANNONE, 55 Dilks Road, Monroeville, NJ, 08343, US

(21) Appl. No.: 10/134,375

(22) Filed: Apr. 30, 2002

(51) Int. Cl. B25B 13/48

(52) U.S. Cl. 81/436

(57) ABSTRACT

A new and improved hand tool device for use in the operation of quarter turn spring loaded self-ejecting or non spring loaded button type fasteners. A device that minimizes damage to costly painted, finished or non finished surface panel or parts due to it's radii and precise fit in the concave groove found in the head of quarter turn fasteners. Comprising of a blade design with specific radii and thickness to fit precisely in the concave grove found in quarter turn spring loaded self-ejecting or non spring loaded button type fasteners.

### FIELD OF INVENTION

This invention is generally directed to a hand tool device for the operation of quarter turn spring loaded self-ejecting or non spring loaded button type fasteners which are generally used in the Automotive Racing and Aviation Industries for the quick assembly and disassembly of sheet metal, fiberglass and other material panels and parts. This would included attaching body panels, hoods, trunk decks and various metal and non-metal parts to the chassis or frame structure. Specifically designed to use at any angle and prevent slippage so that no damage is done to the panel, surface or part being secured.

### BACKGROUND OF THE INVENTION

Race cars, which would include Drag Race, Circle Track, Sprint, Karts and others have been designed to have body panels and various other parts which can be easily removed for maintenance and service. The Aviation Industry had incorporated this technology in it's design. These panels or parts have been secured with quarter turn spring, self-ejecting and non-spring button type fasteners. These fasteners are designed as screw type devise with a slot instead of threads. On the head of the fasteners is a slot like a typical screw, however the difference is that the slot is concave instead of flat. When turned clockwise, a quarter turn, engages a spring type rod which is generally attached to a tab. As a result of the turning movement the panels are mated together and secured into place. To release the panels the fastener is turned counter clockwise.

Typically, the problem encountered with the tools used with these quarter turn fasteners is poor fit in the concave slot causing difficulty in turning. Other problems are slippage and limited angle use. Very often damage has been done to the body panel or surface as a result. Many race cars have very expensive paint work and damage as a result of poor tool design is a major concern for their owners.

One prior art technique is the use of a large blade screwdriver. The flat blade design of the screwdriver does not fit properly into the concave slot on the fastener. Hence it tends to slip out of the slot and cause damage. It is also limited on angle operation since it can only be used at a ninety degree angle.

Another prior art device for use with quarter turn fasteners is marketed by Moroso Performance Products, Inc. of Guilford, Conn. This particular tool is a one piece stamped metal unit which incorporates the handle in it's design. It claims to have three different sized radii to match the slots in various quarter turn fasteners. Upon inspection only two radii are noted which do not achieve enough surface contact in the concave slot to prevent slippage. Also the thickness of the tool itself makes for a very sloppy fit. The flat handle presents another problem as far a leverage and comfort in the use of the tool.

Another prior art device for use with quarter turn fasteners is also marketed by Moroso Performance Products, Inc of Guilford, Conneticut. This particular tool is a modified Screwdriver. It has blade that is contoured to fit inside the slot of the quarter turn fastener. It's design is very limited since the blade does not provide enough surface area to fit the slot properly. This causes slippage due to the poor fit and blade thickness which can result in damage to the panel or surface it is being used on.

Another disadvantage of prior art tools for quarter turn fasteners, is design that the one size blade thickness of the tool will fit all quarter turn fasteners. This is probably the most overlooked aspect of a good tool design for this application. The slots in the fasteners vary in thickness. The present designs do not take that into account. Hence the tools have a sloppy fit which cause slippage and ultimately costly damage to the paint or finish.

It is, therefore, a primary object of the present invention to provide a new and improved tool for use in the operation of securing quarter turn fasteners.

It is another object of the present invention to provide a new and improved tool that will utilize a specifically designed blade with the proper radii to match the radii in the head of the fastener for a secure fit preventing slippage.

It is another object of the present invention to provide a new and improved tool that will utilize various blade thickness' to accommodate the various concave slot sizes in the head of the quarter turn fastener for a precise fit thus preventing slippage.

It is still another object of the present invention to provide a new and improved tool that due to it's blade design will be able to function at various angles not being limited to 90 degrees operation.

It is a further object of the present invention to provide a new and improved tool that will enable the operator to safely and comfortably operate quarter turn fasteners due to it ergonomic design preventing damage prior tools are known for.

### SUMMARY OF THE INVENTION

Briefly stated and in accordance with the preferred embodiment of the invention, a hand tool designed for use in the operation of quarter turn spring loaded self-ejecting or non spring loaded button type fasteners is described comprising of a specially designed blade which conforms to the radii of the concave slot in the quarter turn fasteners providing great contact area. The blade is inserted into a handle to facilitate safe and comfortable operation in the use of quarter turn fasteners. Also comprising of various thickness' to precisely fit into the concave slot of the quarter turn fastener preventing slippage in turn preventing costly damage to painted, finished or non-finished panels, parts or surfaces. Also due to it's size and design allows free operation at almost all angles.

### BRIEF DESCRIPTION OF THE DRAWINGS

While the specification concludes with claims particularly pointing out and distinctly claiming the subject matter regarded as the invention herein, it is believed that the present invention will be more readily understood upon consideration of the description, taken in conjunction with the accompanying drawings, wherein:

FIG. 1 is an exploded view of a hand tool device used in the operation of quarter turn spring loaded self-ejecting or non spring loaded button type fasteners in accordance with the preferred embodiment of the present invention;

FIG.2 is a front view of the specifically designed blade that would be inserted into a handle to comprise a device used in the operation of quarter turn spring loaded self-ejecting or non spring loaded button type fasteners in accordance with the preferred embodiment of the present invention;

FIG.3 is a side view of a handle used to hold the blade for in the operation of quarter turn spring loaded self-ejecting or non spring loaded button type fasteners in accordance with the preferred embodiment of the present invention;

### DESCRIPTION OF THE PREFERRED EMBODIMENT

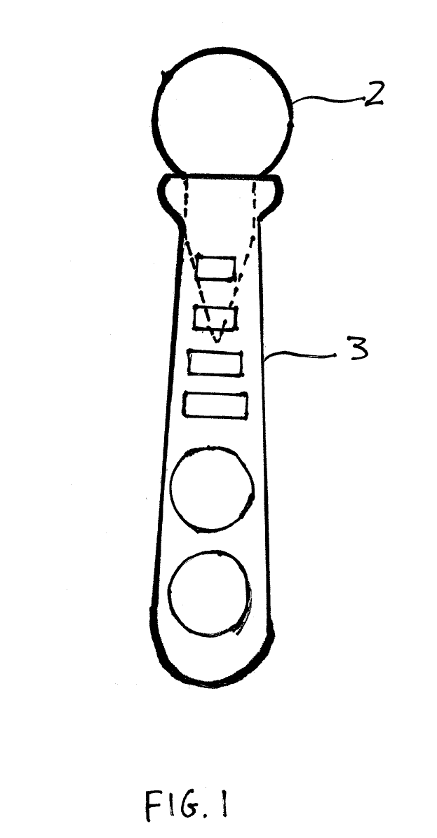

Referring to FIG. 1, an exploded view of the hand tool device of the present invention. The tool comprises a designed blade made of stainless steel, high tensile steel, or other metals. It is inserted into a handle which can be plastic, wood, metal or any other material that could secure the blade. Thus comprising the tool device used in the operation of quarter turn spring loaded self-ejecting or non spring loaded button type fasteners.

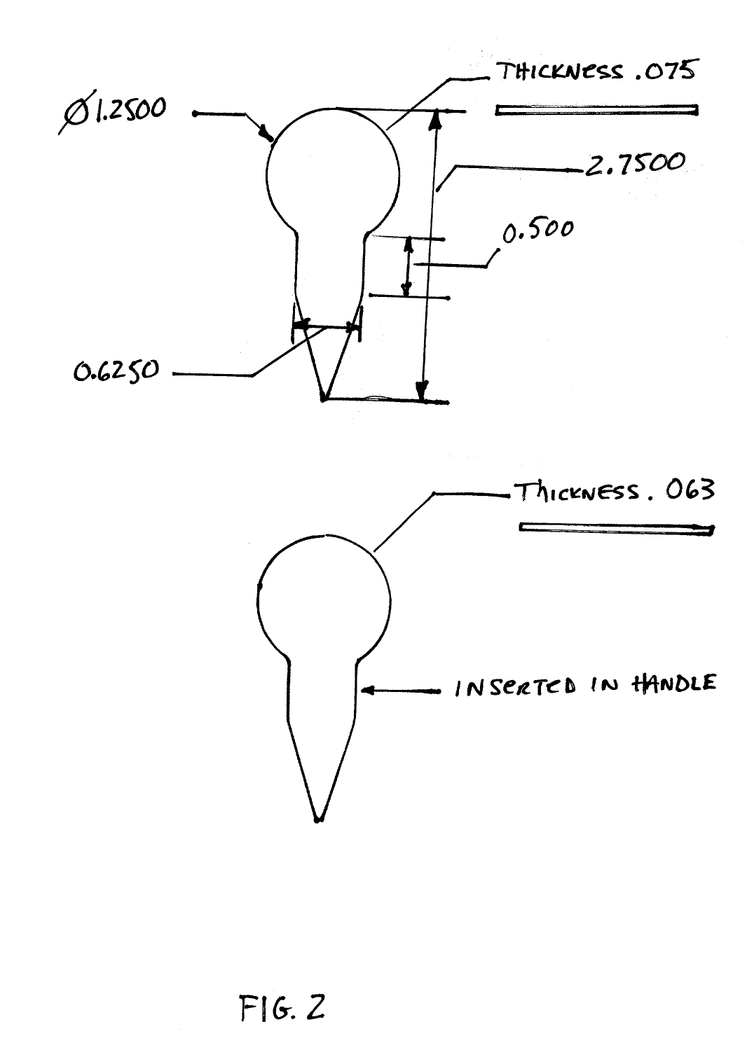

Referring to FIG. 2, is a view of the blade which is made of stainless steel, high tensile steel or any other high strength metal. It is designed with a specific radius of 1.2500″. It's overall length is 2.7500″. The lower portion of the blade is inserted into the handle and secured by heat when using a plastic handle. Also two thickness' are displayed (0.75 & 0.63) to conform with the various size concave grooves found in the heads of the quarter turn fasteners.

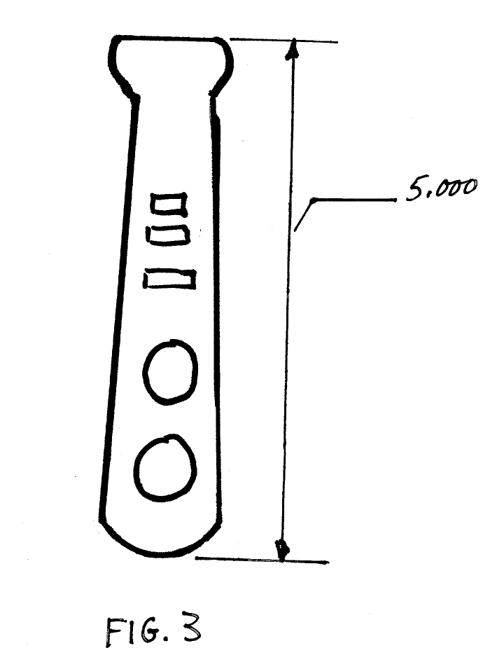

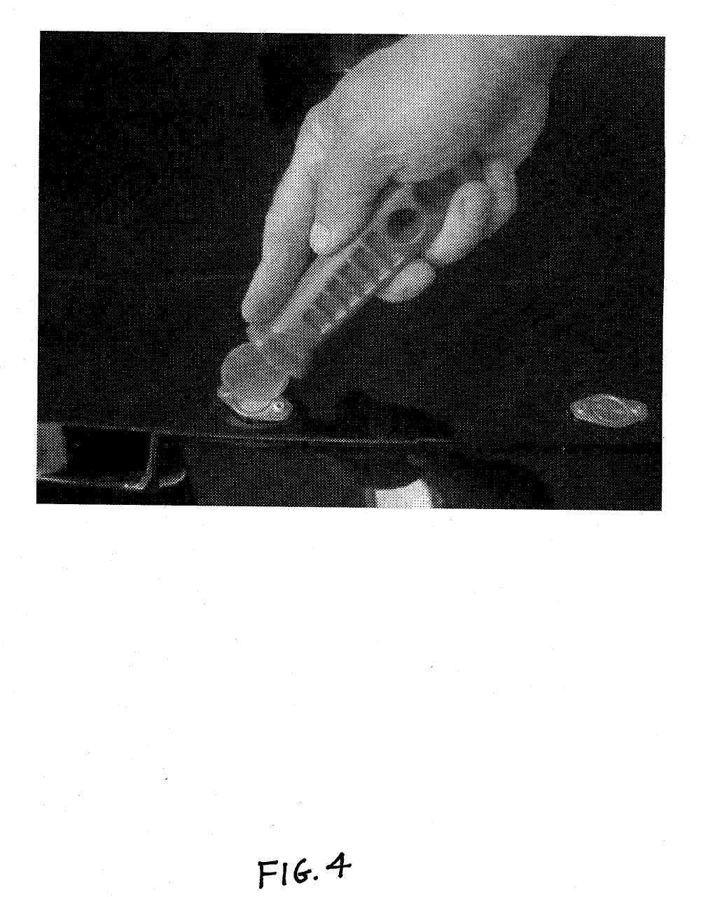

Referring to FIG. 3 is a front view of a typical handle that could house and secure the blade for operation. The handle could be made of plastic, metal, composite, wood or any other material that would be suitable for this application. The present handle of choice is made of plastic which is supplied by the Anglo American Enterprises Corporation of Somerdale, N.J. This particular handle design was chosen for it's ergonomic feel, size and comfort.

Referring to FIG. 4 is an actual photograph of the present invention of the hand tool device used in the operation of quarter turn spring loaded self-ejecting or non spring loaded button type fasteners.

It will be apparent from the foregoing description that the present invention provides a new and improved hand tool device for use in the operation of quarter turn spring loaded self-ejecting or non spring loaded button type fasteners. A device that minimizes damage to costly painted, finished or non finished surfaces, panels or parts due to it's radii and precise fit in the concave groove found in the head of quarter turn fasteners.

While there have been shown and described what is presently considered to be the preferred embodiment of this invention, it will be obvious to those skilled in the art that various changes and modifications may be made without departing from the broader aspects of this invention.

It is, therefore, aimed in the appended claims to cover all such changes and modifications as fall within the true scope and spirit of the invention.

I claim:

1. A hand tool device used in the operation of quarter turn spring loaded self-ejecting or non spring loaded button type fasteners comprising:
a specially designed blade made of stainless steel, high tensile steel or any high strength metal with radii made to fit precisely in the concave groove slot found on quarter turn spring loaded self-ejecting or non spring loaded button type fasteners.
a blade is of various thickness' to accommodate the concave groove slot found on quarter turn spring loaded self-ejecting or non spring loaded button type fasteners.
a blade designed to work at any angle in the operation of quarter turn spring loaded self-ejecting or non spring loaded button type fasteners.
a hand tool device that provides a safe and comfortable manner of operation of quarter turn spring loaded self-ejecting or non spring loaded button type fasteners by preventing slippage due to it's precise fit thus preventing damage to costly painted, finished and non finished panels, surfaces and parts.
